(19) United States
(12) Patent Application Publication
(10) Pub. No.: US 2019/0027909 A1
(43) Pub. Date: Jan. 24, 2019

(54) Cable Tray With Fixing Holes

(71) Applicant: Alstom Transport Technologies, Saint-Ouen (FR)

(72) Inventors: Marc Mifsud, L'etang La Ville (FR); Bernard Puel, Laloubere (FR); Xavier Perez, Barcelona (ES); Patrick Bauer, Zutzendorf (FR); Alexandre Meilhan, Colombes (FR)

(21) Appl. No.: 16/042,348

(22) Filed: Jul. 23, 2018

(30) Foreign Application Priority Data
Jul. 24, 2017 (FR) 1757006

(51) Int. Cl. H02G 3/04; H02G 3/32

(52) U.S. Cl. CPC H02G 3/0456; H02G 3/32

(57) ABSTRACT

The present invention relates to a cable tray extending in a main direction, having attachment holes, each attachment hole having at least one edge, as well as a strip protruding from the edge and comprising a first proximal part relative to the edge and a second distal part.

### CROSS-REFERENCE TO RELATED APPLICATIONS

This application claims priority to FR 17 54006, filed Jul. 24, 2017, which is hereby incorporated by reference in its entirety.

### BACKGROUND OF THE INVENTION

The present invention relates to a cable tray.

The invention also relates to an assembly and a railway vehicle comprising at least one cable tray.

Such a cable tray is, in particular, used to hold several cables traversing an inside or outside environment and to keep them close to a wall. This makes it possible to prevent the cables from hanging or moving and being destroyed.

The use of such a cable tray thus improves the durability of the held cables and the safety of the environment. Furthermore, the esthetic appearance of the environment is significantly improved as a result.

This is particularly desirable in the case of a railway vehicle, where the many electrical and electronic systems on board require a large number of cables traveling from the motor cars through the passenger cars.

In order to effectively attach the cables to the cable tray, it is known to use oblong holes in the structure of the tray, and to attach the cables using gripping collars passing through the oblong holes.

The oblong holes are also used to receive fastening screws for one or several separators, which are used to separate different categories of cables, for example power cables and low-voltage cables.

These cable trays are not, however, fully satisfactory. Indeed, attaching cables on the tray using gripping collars each passing through two oblong holes requires the operator to access the two opposite faces of the tray, which makes the operation tedious.

Thus, one aim of the invention is to provide a cable tray allowing faster and more effective attachment of the cables, while keeping all of the current functionalities.

### BRIEF SUMMARY OF THE INVENTION

To that end, the invention relates to a cable tray of the aforementioned type, extending in a main direction, having attachment holes, each attachment hole having at least one edge as well as a strip protruding from the edge and comprising a first proximal part relative to the edge and a second distal part.

According to specific embodiments, the cable tray according to the invention comprises one or more of the following features, considered alone or according to any technically possible combination(s):
the second part has a width, in a direction substantially orthogonal to the strip, greater than a width of the first part;
the cable tray has oblong holes;
the attachment holes and the oblong holes are arranged so as to form alternating rows;
the cable tray comprises a bottom face and two side faces, arranged such that the cable tray has a U-shaped section in a plane orthogonal to the main direction;
each of the bottom face and the side faces simultaneously has at least one of the oblong holes and at least one of the attachment holes;
each strip extends in the plane of the edge(s) of the attachment hole.

The invention also relates to an assembly comprising a cable tray as previously described, at least one cable extending on the cable tray, and at least one gripping collar attaching the cable to the cable tray, the gripping collar surrounding the cable and the first part of the strip of one of the attachment holes, the second part preferably forming a stop for the gripping collar limiting a translation of the gripping collar along the first part.

According to one specific embodiment, the assembly according to the invention comprises the following feature:
the assembly comprises at least two cables and at least one separator, the cable tray having oblong holes, the separator being attached to the cable tray through at least one oblong hole, the separator separating the cables.

The invention also relates to a railway vehicle comprising at least one assembly as described above, the assembly being attached to a wall of the railway vehicle.

The invention further relates to a method for attaching a cable on one side of a cable tray as described above, in which at least one gripping collar is placed around the cable and gripped around the first part of the strip of one of the attachment holes, the placement and the gripping of the gripping collar being done completely from said side of the cable tray.

### BRIEF DESCRIPTION OF THE DRAWINGS

The invention will be better understood upon reading the following description, provided solely as an example and done in reference to the appended drawings.

FIG. 1 is a partial perspective view of a cable tray according to the invention.

FIG. 2 is a top view of an attachment hole of the cable tray of FIG. 1.

FIG. 3 is a top view of a cable attached to the attachment hole of FIG. 2.

FIG. 4 is a cross-sectional view of the cable tray of FIG. 1 receiving cables and a separator.

FIG. 5 is a partial perspective view of an alternative cable tray according to the invention.

### DETAILED DESCRIPTION OF THE INVENTION

Hereinafter, expressions like “substantially parallel” and “substantially perpendicular” are considered respectively to mean parallel and perpendicular within 10°.

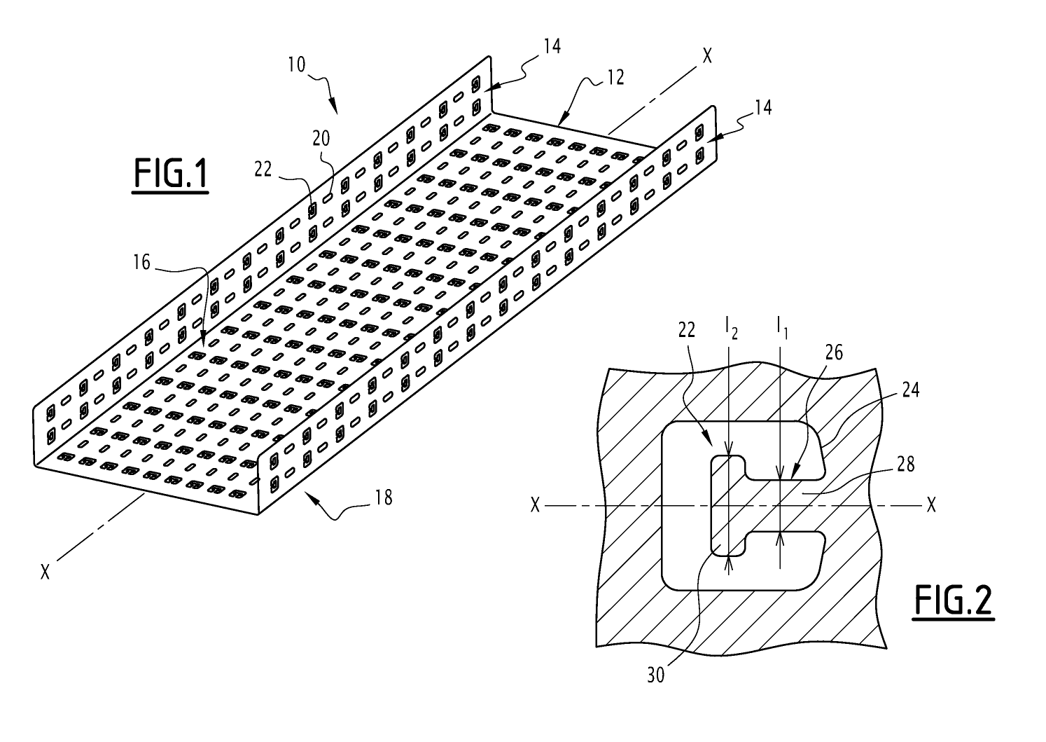

A cable tray 10 according to the invention as shown partially in FIG. 1. The cable tray 10 extends in a main direction X-X, and comprises a bottom face 12 and two side faces 14.

Each of the bottom face 12 and the side faces 14 is rectangular, advantageously elongated in the main direction X-X.

The side faces 14 extend in planes parallel to one another, and substantially orthogonal to a plane in which the bottom face 12 extends. The side faces 14 are connected by a respective edge to opposite edges of the bottom face 12.

The bottom face 12 and the side faces 14 are arranged such that the cable tray 10 has a U-shaped section in a plane orthogonal to the main direction X-X.

According to one embodiment, the bottom face 12 and the side faces 14 are formed from a same sheet bent at a right angle.

Alternatively, the side faces 14 are assembled to the inner face 12 by welding.

The bottom face 12 and the side faces 14 define an inner side 16 of the cable tray 10, and an outer side 18, as shown in FIG. 1. The inner side 16 is intended to receive cables extending substantially parallel to the main direction X-X.

The cable tray 10 has a plurality of oblong holes 20 and a plurality of attachment holes 22. The oblong holes 20 and the attachment holes 22 are through holes and emerge on the inner side 16 and the outer side 18.

Advantageously, each of the bottom face 12 and the side faces 14 simultaneously has at least one of the oblong holes 20 and at least one of the attachment holes 22.

Each oblong hole 20 extends along a direction parallel to the main direction X-X. The oblong holes 20 are arranged in rows orthogonal to the main direction.

Likewise, the attachment holes 22 are arranged in rows orthogonal to the main direction.

Advantageously, the rows of oblong holes 20 and the rows of attachment holes 22 alternate in the main direction X-X, as shown in FIG. 1.

Each attachment hole 22, as shown in FIG. 2, has at least one edge 24, as well as a strip 26 protruding from the edge 24 and extending in the plane of the edge(s) 24 of the attachment hole 22, for example in a direction substantially parallel to the main direction X-X.

The strip 26 comprises a first proximal part 28 relative to the edge 24, and a second distal part 30.

Advantageously, the second part 30 has a width 12, in a direction substantially orthogonal to the strip 26, greater than a width 1i of the first part 28.

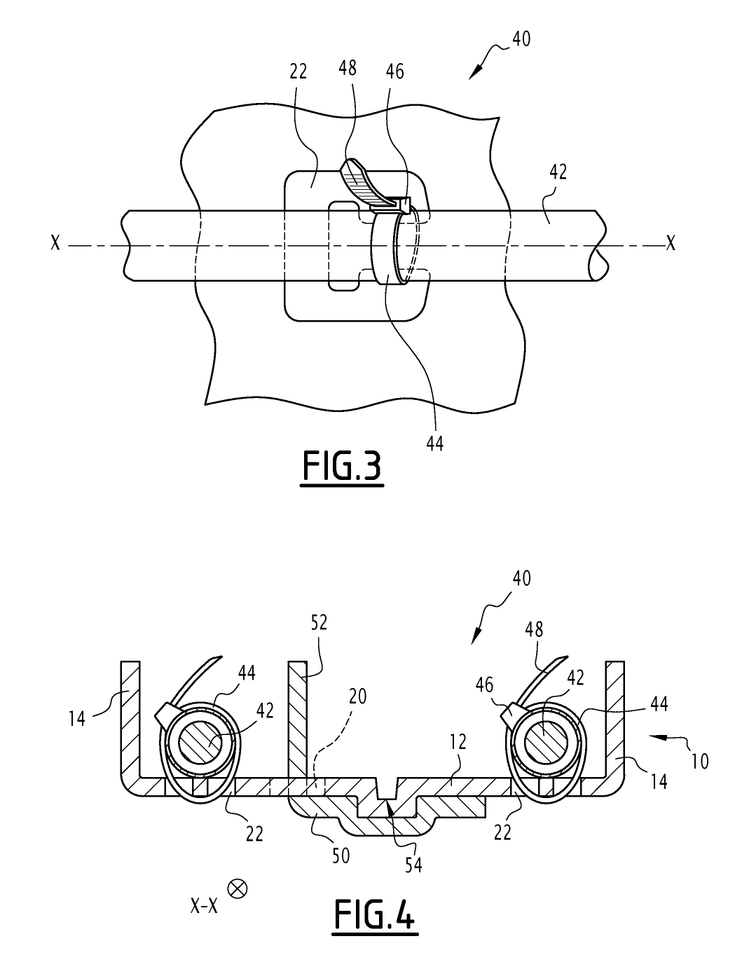

An assembly 40 is shown in FIGS. 3 and 4, including a cable tray 10 as previously described as well as at least one cable 42 and at least one gripping collar 44.

The gripping collar 44 includes a head 46 and a band 48 connected to the head 46 by a first end. The band 48 is suitable for being engaged in an opening of the head 46 by its free end, irreversibly.

The gripping collar 44 narrowly surrounds the cable 42 and the first part 28 of the strip 26 of one of the attachment holes 22.

The second part 30 of the strip 26 is wider than the first part 28, such that the gripping collar 44 is limited and, preferably, blocked in its translational movements in the main direction X-X by the second part 30. In other words, the second part 30 forms a stop for the gripping collar 44 limiting a translation of the gripping collar 44 along the first part 28.

According to one embodiment shown in FIG. 4, the assembly 40 comprises at least one separator 50 attached to the cable tray 10.

The separator 50 is a sheet comprising tabs 52 protruding at a right angle. Each tab 52 is slid into an oblong hole 20 of the bottom face 12. The separator 50 is attached to the bottom face 12, on the outer side 18, for example by clinching, i.e., by stamping the separator 50 and the bottom face 12 on a contact zone 54.

The separator 50 is used in order to separate the cables 42 attached to the cable tray 10 in a direction orthogonal to the main direction X-X, for example to separate power cables and low-voltage cables.

The assembly 40 is for example intended to be attached to a wall of a railway vehicle such that the cable tray 10 keeps the cables 42 close to the wall. This in particular makes it possible to convey the cables 42 transmitting electrical power or information through the passenger cars of a train, and to keep them against the walls of the passenger cars, for example to protect them and reduce the risks that they may represent, or to hide them with cladding elements.

The use of the cable tray 10 is deduced from its structure, and will now be briefly described.

The user attaches a cable 42 to the cable tray 10 by placing a gripping collar 44 around the cable 42, then tightens the gripping collar 44 around the first part 28 of the strip 26, the placement and the tightening of the gripping collar 44 being done completely from the inner side 16.

Owing to the features described above, the cable tray 10 allows a faster and more secure attachment of the cables 42, while retaining all of the previously existing functionalities.

The cable tray 10 comprises rows of attachment holes 22 having a strip 26, which allow easy attachment of a cable 42 from a single side of the cable tray 10. This allows a single user to attach a cable 42 without having to bypass the cable tray 10, facilitating and accelerating the process.

Indeed, a cable tray including only oblong holes 20 requires passing the gripping collar 44 through two adjacent oblong holes 20, which requires the user to access the inner side 16 and the outer side 18.

This greatly facilitates the installation of cables 42 on the cable tray 10, which may require the placement of many gripping collars 44.

The cable tray 10 is advantageous, since the attachment holes 22 have a strip 26 including a second part 30 that is wider than the first part 28, which allows effective blocking of the gripping collar 44.

The cable tray 10 also comprises oblong holes 20 arranged in rows orthogonal to the main direction X-X, which allows a fast and configurable installation of the separator 50.

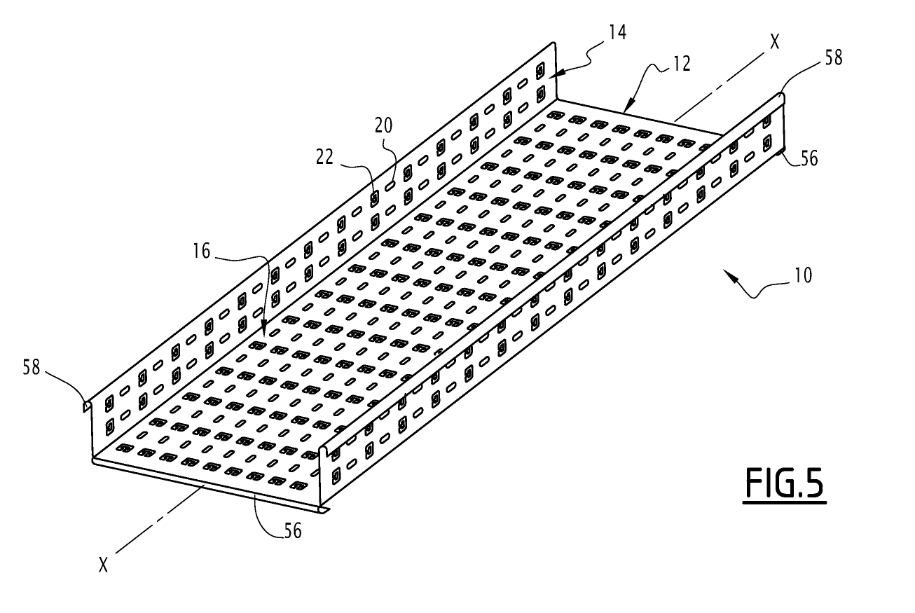

According to an alternative shown in FIG. 5, each edge of the bottom face 12 transverse to the main direction X-X has an end bend 56, made by bending the material of the end edge of the bottom face 12 toward the outer side 18. Likewise, each upper edge of the side faces 14 has a longitudinal bend 58 made by bending the material of the upper edge of the bottom face 12 toward the outer side 18. The end bends 56 and the longitudinal bends 58 make it possible to protect the insulating sheaths of the cables 52, which extend past the cable tray 10, above the end edges or the upper edges, the edges otherwise potentially being sharp.

1. A cable tray extending in a main direction, having attachment holes, each attachment hole having at least one edge as well as a strip protruding from the edge and comprising a first proximal part relative to the edge and a second distal part, the cable tray also having oblong holes, the cable tray comprising a bottom face and two side faces, arranged such that the cable tray has a U-shaped section in a plane orthogonal to the main direction, each of the bottom face and the side faces having both at least one of the oblong holes and at least one of the attachment holes.

2. The cable tray according to claim 1, wherein the second part has a width, in a direction substantially orthogonal to the strip, greater than a width of the first part.

3. The cable tray according to claim 1, wherein the attachment holes and the oblong holes are arranged so as to form alternating rows.

4. The cable tray according to claim 1, wherein each strip extends in the plane of the edge(s) of the attachment hole.

5. An assembly comprising the cable tray according to claim 1, at least one cable extending on the cable tray, and at least one gripping collar attaching the cable to the cable tray, the gripping collar surrounding the cable and the first part of the strip of one of the attachment holes, the second part preferably forming a stop for the gripping collar limiting a translation of the gripping collar along the first part.

6. The assembly according to claim 5, wherein the assembly comprises at least two cables and at least one separator, the cable tray having oblong holes, the separator being attached to the cable tray through at least one oblong hole, the separator separating the cables.

7. A railway vehicle comprising at least one assembly according to claim 5, the assembly being attached to a wall of the railway vehicle.

8. A method for attaching a cable on one side of the cable tray according to claim 1, the method comprising:
placing at least one gripping collar around the cable; and
tightening the at least one gripping collar around the first part of the strip of one of the attachment holes;
wherein the placement and the tightening of the gripping collar are done completely from said side of the cable tray.
